(19) United States
(12) Patent Application Publication
(10) Pub. No.: US 2002/0003598 A1
(43) Pub. Date: Jan. 10, 2002

(54) LIQUID CRYSTAL DISPLAY WITH IMPROVED FIELD OF VIEW

(76) Inventors: MARTIN J. STEFFENSMEIER, CEDAR RAPIDS, IA (US); CRAIG E. HARWOOD, CEDAR RAPIDS, IA (US)

Correspondence Address: KYLE EPPELE, ROCKWELL COLLINS INC, 400 COLLINS ROAD NE, CEDAR RAPIDS, IA, 52498

(21) Appl. No.: 09/277,523

(22) Filed: Mar. 26, 1999

(51) Int. Cl. G02F 1/1337

(52) U.S. Cl. 349/129

(57) ABSTRACT

A liquid crystal display utilizes a dual-domain architecture to improve contrast, gray-scale linearity, and hue-angle performance over field of view. The dual domains can have angles of orientation or partitions which are not directly opposite. Also, the dual domains can employ an angle of twist of a value of less than or greater than 90°. By utilizing angles of orientation which are not opposite and angles of twist which are not 90°, the dual-domain structure can compensate for poor contrast, gray-scale linearity, and hue-angle performance. The liquid crystal display can be a twisted nematic liquid crystal display that does not require a multi gap color filter. The display can be a normally white or normally black display for use in avionic applications.

### FIELD OF THE INVENTION

The invention relates generally to the field of liquid crystal displays (LCDs). More particularly, the present invention relates to techniques for improving the field of view of a liquid crystal display.

### BACKGROUND OF THE INVENTION

In general, it is desirous to provide improved contrast, gray-scale linearity, and hue-angle (i.e., chromaticity) performance over the field of view of conventional displays. These parameters are particularly important in avionic systems and other high-definition viewing applications, such as, twisted nematic active matrix, back panel liquid crystal displays (LCDs).

In conventional display systems, such as, LCDs, a matrix of pixels is controlled by electrical signals to provide a static or a dynamic graphic image. If the display is a color display, each pixel can be comprised of a red element, a green element, and a blue element. An element can be comprised of a single liquid crystal domain or a dual liquid crystal domain or many liquid crystal domains. The liquid crystal domain is controlled by a thin-film transistor (TFT). The domains (i.e., partitions) include a collection of nematic molecules which are manipulated by electrical signals provided by the thin-film transistors. Thus, each thin-film transistor causes a particular amount of light to be transmitted through its associated element.

In conventional systems, contrast, gray-scale stability and or linearity, and hue-angle performance degrade significantly as the viewing angle changes. The contrast in conventional LCDs is usually a maximum within a narrow viewing angle centered about a normal angle and diminishes quickly as the angle of view is changed. This loss of contrast at large viewing angles is caused by light leaking through pixel elements. In color LCDs, such leakage can also cause severe color shifts for both saturated and gray-scale colors (e.g., poor hue-angle performance).

The field of view in typical twisted-nematic LCDs is often severely limited because, in addition to color degradation caused by dark leakage, the optical anisotrophy of the nematic liquid crystal molecules results in large variations of gray-scale transmission (i.e., a shift in the brightness-voltage curve), as a function of viewing angle. The variation is often so severe that some pixels reverse their transmission levels at extreme viewing angles. These limitations are particularly disadvantageous in applications requiring a very high-quality display, such as, in avionics, where cockpit displays must be viewed from both pilot and co-pilot seating positions. Also, high information content displays, such as, aviation displays, require that the relative gray-scale transmission be as invariant as possible with respect to viewing angle.

As shown in FIG. 1, a conventional full-color, single-tilt domain display 100 includes a polarizer 105, an analyzer 110, a liquid crystal cell 115, and one or more compensator layers 120. Liquid crystal cell 115 includes an active matrix substrate 125, a color matrix substrate 130, and liquid crystal material 135. Polarizer 105 and analyzer 110 both polarize electromagnetic energy. However, the term “polarizer” typically refers to a polarizer element that is closest to the source of light, while the term “analyzer” refers to a polarizer element that is closest to a viewer of the LCD.

Substrate 125 includes an array of TFTs, transparent electrodes, address lines, and an alignment layer. The address lines activate individual liquid crystal display elements via the TFTs. The color matrix substrate 130 can include a black matrix coating, a color filter matrix, a transparent electrode, and an alignment layer. The alignment layers on the active matrix substrate layer 125 and color matrix substrate layer 130 act in combination to induce twisted nematic orientation in liquid crystal material 135.

With reference to FIG. 2, a dual domain LCD system 150 is similar to the system 100 described with reference to FIG. 1. System 150 includes a collection of nematic molecules 200 disposed between a pair of substrates 205 and 210. Substrate 205 has been rubbed in a direction 215 to the right and a direction 220 to the left. Direction 215 is directly opposite (i.e., 180° degrees apart) to direction 220. Similarly, substrate 210 is rubbed in a direction 225 into the page and in a direction 230 out of the page. Direction 225 is directly opposite to direction 230. Directions 215 and 220 are arranged at 90° angles with respect to directions 225 and 230, respectively. This rubbing configuration produces two twist domains 235 and 240.

Rubbing directions 215 and 225 cause twist domains 235 to have a twist angle of 90° and to have an angle of orientation of 0°. Twist directions 220 and 230 cause domains 240 to have a twist angle of 90° and to have an angle of orientation of 180°. Accordingly, domains 235 and 240 have directly opposite angles of orientation (e.g., 180° apart).

System 150 can average the gray-scale behavior of the display over positive and negative vertical viewing directions. Such averaging can produce improved gray-scale linearity over the field of view. Additionally, system 150 can include a compensator structure incorporating an oblique-oriented, positively birefringent compensator element referred to as an O-plate compensator. The O-plate compensator structure significantly improves gray-scale linearity and provides high contrast over large variations in viewing directions for single domain twisted-nematic LCD architectures. However, O-plate compensators can be expensive and difficult to manufacture. Further, conventional dual-domain systems often utilize a multi gap color filter for achieving improved chromaticity stability. However, such devices are difficult to produce and are costly.

Thus, there is a need for a liquid crystal display having improved contrast and/or gray-scale linearity and/or hue-angle performance over the field of view. Further still, there is a need for a liquid crystal display which does not require a multi-gap color filter.

### SUMMARY OF THE INVENTION

The present invention is related to a twisted nematic liquid crystal display having a field of view. The liquid crystal display includes a liquid crystal cell having a plurality of pixel elements. The pixel elements are comprised of a first domain and a second domain. The first domain has a first angle of orientation and a first twist. The second domain has a second angle of orientation. The first angle of orientation is not opposite the second angle of orientation or the first twist is not equal to 90° to improve the performance over the field of view.

The present invention further relates to a liquid crystal display including a liquid crystal cell that has an array of elements. The elements are comprised of a first partition and a second partition. The first partition has a first angle of orientation and a first twist. The second partition has a second angle of orientation. The first angle of orientation is not opposite the second angle of orientation or the first twist is not equal to 90° to improve the gray-scale linearity over a field of view.

The present invention still further relates to a method of obtaining an optimized field of view for a liquid crystal display including an array of elements. The method includes providing a first partition for each element, which has a first angle of orientation and a first twist, and providing a second partition for each element, which has a second angle of orientation. The first angle of orientation is not opposite the second angle of orientation or the first twist is not equal to 90° to provide the optimized field of view.

### BRIEF DESCRIPTION OF THE DRAWINGS

The present invention will hereafter be described with reference to the accompanying drawings, wherein like numerals denote like elements and:

FIG. 1 is a cross-sectional view of a conventional, single-domain liquid crystal display system;

FIG. 2 is a cross-sectional view of a conventional, dual-domain, twisted nematic liquid crystal display system; and

FIG. 3 is a cross-sectional view of a liquid crystal display in accordance with an exemplary embodiment of the present invention.

### DETAILED DESCRIPTION OF PREFERRED EXEMPLARY EMBODIMENTS

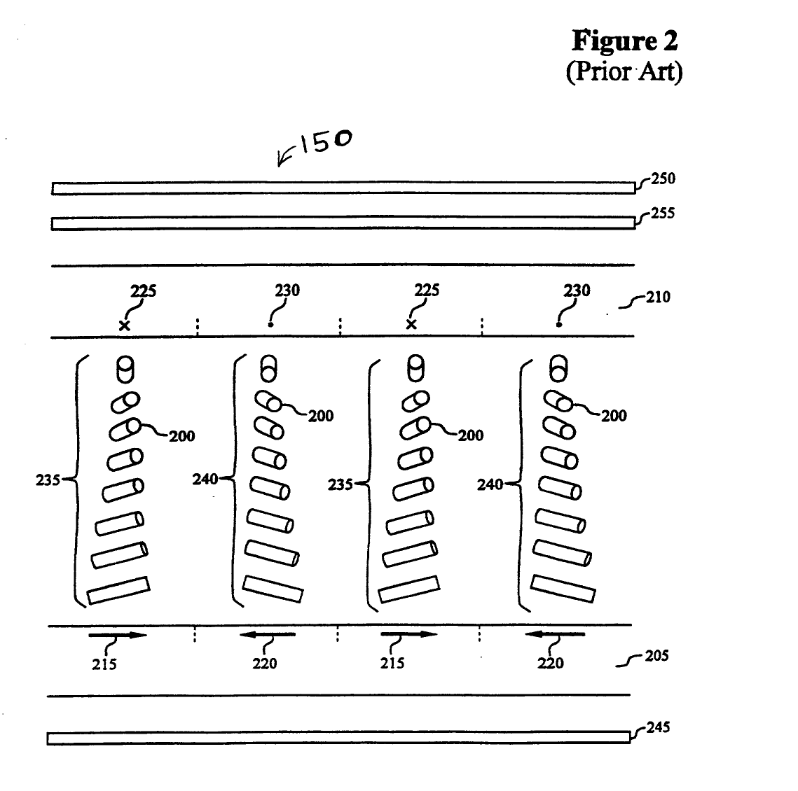

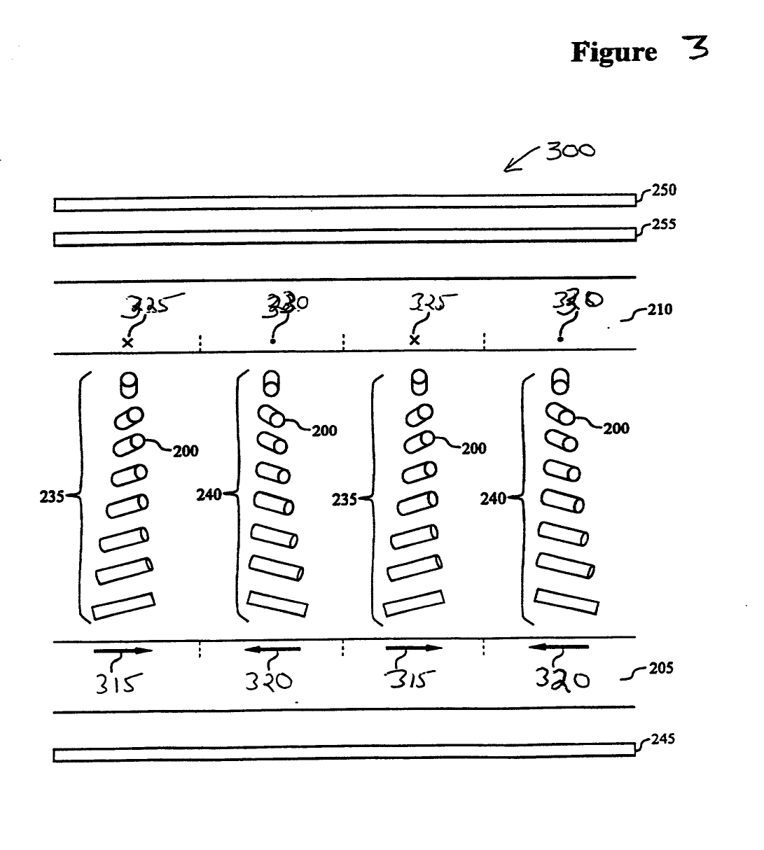

With reference to FIG. 3, a dual-domain LCD system 300 is configured for use as an avionic display system. System 300 has an optimized field of view where contrast, gray-scale stability and/or linearity, and hue-angle performance are improved relative to conventional systems as viewing angle increases. System 300 advantageously can operate without the use of a multi-gap color filter or expensive compensator layers, such as, layer 205 (FIGS. 2 and 3).

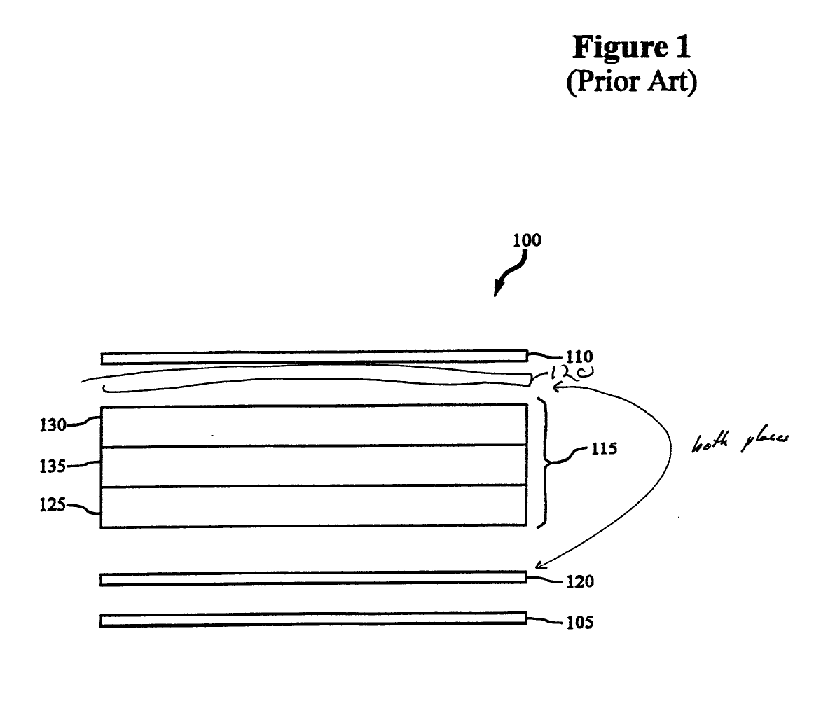

System 300 is similar to system 150 described with reference to FIG. 1. However, system 300 has rubbing directions changed to compensate for contrast, gray-scale stability and/or linearity, and hue-angle performance over the field of view. Additionally, system 300 can be comprised of a number of different partitions instead of only partitions 235 and 240, as shown in FIG. 3.

System 300 can include dual domains for each of red, green, and blue elements for a total of six domains. Each domain can have its own twist angle and rub orientation (e.g., the rub is the liquid crystal alignment parameter). Such a concept can eliminate the need for multi gap color filters. Alternatively, the twist angle and alignment parameters can be configured utilizing other methods.

As shown in FIG. 3, system 300 includes a collection of nematic molecules 200 disposed between a pair of substrates 205 and 210. Substrate 205 has been rubbed in a direction 315 generally to the right and a direction 320 generally to the left. Unlike conventional systems, directions 315 and 320 are not necessarily directly opposite (e.g., more than or less than 180° apart). Similarly, substrate 210 is rubbed in a direction 325 generally into the page and a direction 330 generally out of the page. These rubbing configurations produce two twist domains 235 and 240.

Directions 315 and 320 can be arranged at 90° angles with respect to directions 325 and 330, respectively. Alternatively, directions 315 and 320 can be arranged at slightly more than or less than 90° angles with respect to directions 325 and 330, respectively. For example, by having an angle of twist (e.g., defined by directions 315 and 325) less than 90°, domain 235 can compensate for domain 240 to improve contrast, hue-angle, and gray-scale stability and/or linearity performance over the field of view. Similarly, by having directions 315 and 320, which define the angle of orientation of domain 235 and 230, different than 180° apart (e.g., not directly opposite), system 300 can compensate for contrast, gray-scale linearity, and hue-angle degradation over the field of view. Preferably, the angle of twist of domains 235 and 240 is not equal to 90° and is between 75° and 105°. Preferably, the angle of twist is between 85° and 95°. Also, the difference between the angle of orientation of domains 235 and 240 is between 165° and 205°; preferably, the difference is between 175° and 185°.

System 300 can also be configured so that one of domains 235 and 240 has a conventional angle of orientation and an angle of twist, while the other does not. For example, although domain 235 can have an angle of twist of not equal to 90°, domain 240 can have an angle of twist equal to 90° if the compensation scheme so requires. Any number of rubbing directions and angles can be utilized to achieve the advantages of the present invention. Table 1 below defines exemplary examples of angles for directions 315 and 325. Table 1 shows the difference in the orientation angles with angles of twists for various rubbing directions.

TABLE 1

| Parameter | Value | | | | | | | | | | |
|---|---|---|---|---|---|---|---|---|---|---|---|
| Direction 315 | 0 | 0 | 0 | 5 | 0 | 0 | 5 | 0 | 15 | 0 | 0 |
| Direction 320 | 180 | 175 | 180 | 180 | 185 | 165 | 180 | 190 | 180 | 205 | 180 |
| Direction 325 | 88 | 90 | 90 | 95 | 90 | 90 | 95 | 100 | 90 | 90 | 105 |
| Direction 330 | 270 | 265 | 272 | 270 | 275 | 270 | 270 | 270 | 280 | 295 | 270 |
| Domain 235-Twist | 88 | 90 | 90 | 90 | 90 | 90 | 90 | 100 | 75 | 90 | 105 |
| Domain 240-Twist | 90 | 90 | 92 | 90 | 90 | 105 | 90 | 80 | 110 | 90 | 90 |
| Domain 235-Orientation | 44 | 45 | 45 | 500 | 45 | 45 | 50 | 50 | 52.5 | 45 | 52.5 |
| Domain 240-Orientation | 225 | 220 | 226 | 225 | 230 | 217.52 | 225 | 230 | 235 | 250 | 225 |
| Difference in | 181 | 175 | 181 | 175 | 185 | 172.5 | 175 | 180 | 183.5 | 205 | 173.5 |
| Orientation | | | | | | | | | | | |

As can be seen from Table 1, a variety of values can be utilized to configure system 300 for various viewing angles. For example, differences in the angle of orientation can vary from 165° to 205°, and angles of twist can range from 75° to 105°.

It is understood that, while the detailed drawings, specific examples, and particular components given describe a preferred exemplary embodiment of the present invention, they are for the purpose of illustration only. The apparatus of the invention is not limited to the precise details and conditions disclosed. For example, although a twisted nematic display is described, other types of liquid crystal display systems may utilize the principles of the present invention. Various changes may be made to the details disclosed without departing from the spirit of the invention, which is defined by the following claims.

What is claimed is:

1. A twisted nematic liquid crystal display having a field of view, the liquid crystal display comprising:
a liquid crystal cell having a plurality of pixel elements, the pixel elements being comprised of a first domain and a second domain, the first domain having a first angle of orientation and a first twist, the second domain having a second angle of orientation and a second twist, wherein the first angle of orientation is not opposite the second angle of orientation or the first twist is not equal to ninety degrees to improve the hue-angle performance over the field of view.

2. The liquid crystal display of claim 1, wherein each element includes a red filter, a blue filter, or a green filter.

3. The liquid crystal display of claim 1, wherein the display is a normally white display.

4. The liquid crystal display of claim 1, wherein the display is a normally black display.

5. The liquid crystal display of claim 1, wherein the angle of orientation for the first twist is between 70° and 110°.

6. The liquid crystal display of claim 1, wherein an absolute value of a difference between the first angle of orientation and the second angle of orientation is less than 20°.

7. The liquid crystal display of claim 1, wherein the display is an avionic display, and the field of view has an oval-like shape.

8. A liquid crystal display, comprising:
a liquid crystal cell including an array of elements, the elements being comprised of a first partition and a second partition, the first partition having a first angle of orientation and a first twist, the second partition having a second angle of orientation and a second twist, wherein the first angle of orientation is not opposite the second angle of orientation or the first twist is not equal to ninety degrees to improve the gray-scale linearity over a field of view.

9. The liquid crystal display of claim 8, wherein the first twist is between 70 and 110 degrees.

10. The liquid crystal display of claim 8, wherein the first twist is between 85 and 95 degrees.

11. The liquid crystal display of claim 8, wherein an absolute value of a difference of the first angle of orientation and the second angle of orientation is less than 30 degrees and not equal to zero.

12. The liquid crystal display of claim 8, wherein the display is an avionic display.

13. The liquid crystal display of claim 8, wherein the display is an avionic display, and the field of view has an oval-like shape.

14. The liquid crystal display of claim 8, wherein each element includes a red filter, a blue filter and a green filter.

15. The liquid crystal display of claim 8, wherein the display is a normally white display.

16. The liquid crystal display of claim 8, wherein the display is a normally black display.

17. A method of obtaining an optimized field of view for a liquid crystal display including an array of elements, the method comprising:
providing a first partition for each element, the first partition having a first angle of orientation and a first twist;
providing a second partition for each element, the second partition having a second angle of orientation; and
wherein the first angle of orientation is not opposite the second angle of orientation or the first twist is not equal to ninety degrees to provide the optimized field of view.

18. The method of claim 17, wherein the optimized field of view has an oval shape.

19. The method of claim 18, wherein the first twist is within 10 degrees of ninety degrees.

20. The method of claim 19, wherein the first twist is adjusted to improve the field of view over a vertical axis associated with the display.

21. The method of claim 17, wherein an absolute value of a difference of the first angle of orientation and the second angle of orientation is less than 20 degrees.

22. The method of claim 17, wherein the display is an active matrix, twisted nematic display.
